(19) United States
(12) Patent Application Publication
(10) Pub. No.: US 2003/0097457 A1
(43) Pub. Date: May 22, 2003

(54) Scalable multiprocessor architecture for business computer platforms

(76) Inventors: Amitabh Saran, Bangalore (IN); Mathews Manaloor, Hillsboro, OR (US); Arun Maheshwari, Bangalore (IN); Sanjay Suri, Bangalore (IN); Tarak Goradia, Bangalore (IN)

Correspondence Address: STOEL RIVES LLP, 900 SW FIFTH AVENUE, SUITE 2600, PORTLAND, OR, 97204, US

(21) Appl. No.: 10/216,657

(22) Filed: Aug. 8, 2002

Related U.S. Application Data
(60) Provisional application No. 60/311,019, filed on Aug. 8, 2001.

(51) Int. Cl. G06F 17/60; G06F 15/16

(52) U.S. Cl. 709/230; 705/7

(57) ABSTRACT

A scalable software architecture (20) for business computer platforms implements a messaging platform (FIG. 3) for communicating messages among various dynamically connected components, preferably including a communication gateway (28) for communication with at least one external media channel (52-62), a data manager layer (22) for maintaining data in a connected database system (40), and a business workflow engine (26) for implementing predetermined business workflows leveraging customized business logic and business software objects (22). The messaging platform comprises a managing process (502) and at least one agent process (504) forming a serial chain for distributed port number assignments and implementing client registration (Table 1) for robust, reliable messaging.

### RELATED APPLICATIONS

This application is a continuation of and claims priority from U.S. Provisional Application No. 60/311,019 filed Aug. 8, 2001.

### COPYRIGHT NOTICE

© 2002 TriVium Systems, Inc. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This application pertains to computer systems and in particular to a scalable, generic software architecture for a business computer platform that is easily adaptable to a wide variety of industries and business applications, especially environments that require high volume, near real-time interaction with customers and other users over various communication channels.

### BACKGROUND OF THE INVENTION

One aspect of this evolution is the need to interact with customers or business partners effectively over a variety of communication channels. While conventional mail and the telephone are still used, the many advantages and falling costs of other channels such as the Internet, VoIP, wireless PDAs, fax, WLAN etc. make them increasingly attractive to business users and their customers. At the same time, the availability of these and other channels presents a challenge to manage communications, regardless of the channel in use, in a unified way. To take a simple example, a user should be able to place an order via fax, and later check the status of that order via email, with no particular difficulty and ideally without human intervention on the vendor side.

On the other hand, communications channels are changing and evolving very rapidly, and which channels will dominate in the future is hard to predict. Yet businesses cannot afford to continually re-tool their computers and communication systems. What is needed is a platform that can be adapted, simply and therefore inexpensively, to accommodate changing communication channel requirements. Yesterday's automated fax server, for example, must become tomorrow's high-volume interactive Internet site—without substantial new investment.

The need remains for a business computer architecture that provides the following features:

Seamless, consistent and unified channels/media of customer and partner interaction

Integrated workflow to manage these business interactions

Business Intelligence and Analytical capabilities

XML based interfaces for building applications—also for deployment, maintenance and upgrading of applications.

Customer self-help capabilities—integrated with other aspects of the system.

Various software systems and architectures are known in the prior art, for a wide variety of business applications. One such system is described in U.S. Pat. No. 6,067,525 to Johnson et al. entitled, “Integrated Computerized Sales Force Automation System.” That system integrates salesperson support for multiple phases of the sales process (Abstract). The patent discloses a “layered architecture” illustrated at FIG. 20. The figure shows application, business objects, data and platform layers. The specification explains, “the layers communicate with each other through three defined protocols illustrated as protocol layers 2001, 2003 and 2005 . . .” See column 31, lines 13 et seq. Because this vertical “layered” architecture requires a specific, dedicated protocol for communication at each level, changes at every level are constrained by the communication protocols. Integration with new components and external systems is cumbersome.

The need remains for an improved architecture that includes a simpler, flatter arrangement for communications among various components. New software components and third-party systems should be easy to integrate without having to design to or modify multiple protocols.

### SUMMARY OF THE INVENTION

According to one aspect of the invention, a scalable distributed architecture enables a generic business computing platform that is easily customizable to implement and effectively support the business policies and procedures (business logic) of almost any commercial enterprise, especially those engaged in sales of products and/or services. Using the Extensible Markup Language (XML) based interfaces for data interchange, the generic platform can be used to create business applications for various vertical markets and various information viewing devices (computer monitors, web browsers, flat data files, spreadsheets, hand-held devices and the like). The scalable architecture is centered around a novel “messaging platform” for communication of messages among various components. The messaging platform is robust, automatically extensible and fast as detailed below.

The messaging platform effectively interconnects as many components as may be appropriate to the user's business. For example, most businesses need effective customer relationship management or “CRM.” This requires means for communicating with customers via various media or “interaction channels” including but not limited to email, fax, telephone, VoIP, IVR, Internet web sites, handheld wireless devices, etc. Each such channel is connected to a corresponding media adapter in the present system, and each media adapter is a component that connects (directly or through a gateway) to the messaging platform. Communications with customers are reflected as messages on the messaging platform as explained in detail later.

Another aspect of the invention is the business workflow engine. As the name implies, this component implements the user's business logic, for example, updating a record or sending a reply in response to an incoming email (that is, in response to a message on the messaging platform that reflects the incoming email). The workflow engine does its work by sending other messages onto the bus, for example a message to a data manager (“DM”) component to query or update customer records. Thus the data manager is another example of a component connected to the messaging bus of the scalable business platform. Each of these components has a corresponding “connection” or “connector” to the messaging platform to send and receive messages. The messaging platform opens and closes connections dynamically, as further explained later, and has mechanisms to make it scalable and highly reliable. In a presently preferred embodiment, a gated security system is implemented within the platform adapters/connectors so that not every component can view all the messages floating in the platform.

In general, anything that can generate or act on a message (typically, a process or software component) can be connected to the messaging platform, through an appropriate connector, and thereby “plug into” the present platform. Other components might be a truck (by wireless connection), an industrial process or machinery, or a point-sale-sale (POS) terminal; the applications are unlimited. In many cases, the necessary components interact with the business platform through messages via the message platform. The architecture disclosed herein effectively gives a component access to every other component connected to the bus, although that access generally is mediated by a predefined workflow process. The messaging platform obviates the need for various components to implement multiple different protocols and interfaces to other elements of the platform. Moreover, external systems and programs can also connect to the bus as will be shown. Finally, external processes can access specific components more directly via API's and event services where it is advantageous to do so.

In one embodiment, the entire business platform is run on a multiprocessor machine. Alternatively, each of the components, for example the messaging platform managers and agents, can execute on separate even disparate machines and yet be able to communicate with each other. This property allows the platform to scale gracefully, e.g., if the workflow component becomes heavily used (too many web calls or emails being routed), it can be spawned off on another machine so that it doesn't affect the performance of the rest of the platform.

Additional aspects and advantages of this invention will be apparent from the following detailed description of preferred embodiments thereof, which proceeds with reference to the accompanying drawings.

### BRIEF DESCRIPTION OF THE DRAWINGS

FIG. 1 is a simplified block diagram illustrating a scalable architecture for business computing platforms in accordance with the present invention.

FIG. 2 is a first conceptual diagram illustrating operation of the messaging platform of FIG. 1.

FIG. 3 is a second conceptual diagram illustrating operation of the messaging platform of FIG. 1.

FIG. 4 is a third conceptual diagram illustrating operation of the messaging platform of FIG. 1.

FIG. 5A is a generic example of a message for transmission via the messaging platform of FIG. 1.

FIG. 5B shows the generic message of FIG. 5A in greater detail.

FIG. 5C shows a payload of the generic message of FIG. 5A in greater detail.

FIG. 6A is an example of a message from a hand-held inventory scanner (“HIS”) adapter to a workflow component to download physical inventory data.

FIG. 6B is an example of a message from a workflow component to a data manager to update inventory data.

FIG. 6C is an example of a message from a data manager to a workflow component responding to an inventory update message.

FIG. 7 is a simplified data flow diagram illustrating an events model for third-party integration to the platform of FIG. 1.

FIG. 8 illustrates another event-based method of third-party system integration.

### DETAILED DESCRIPTION OF PREFERRED EMBODIMENTS

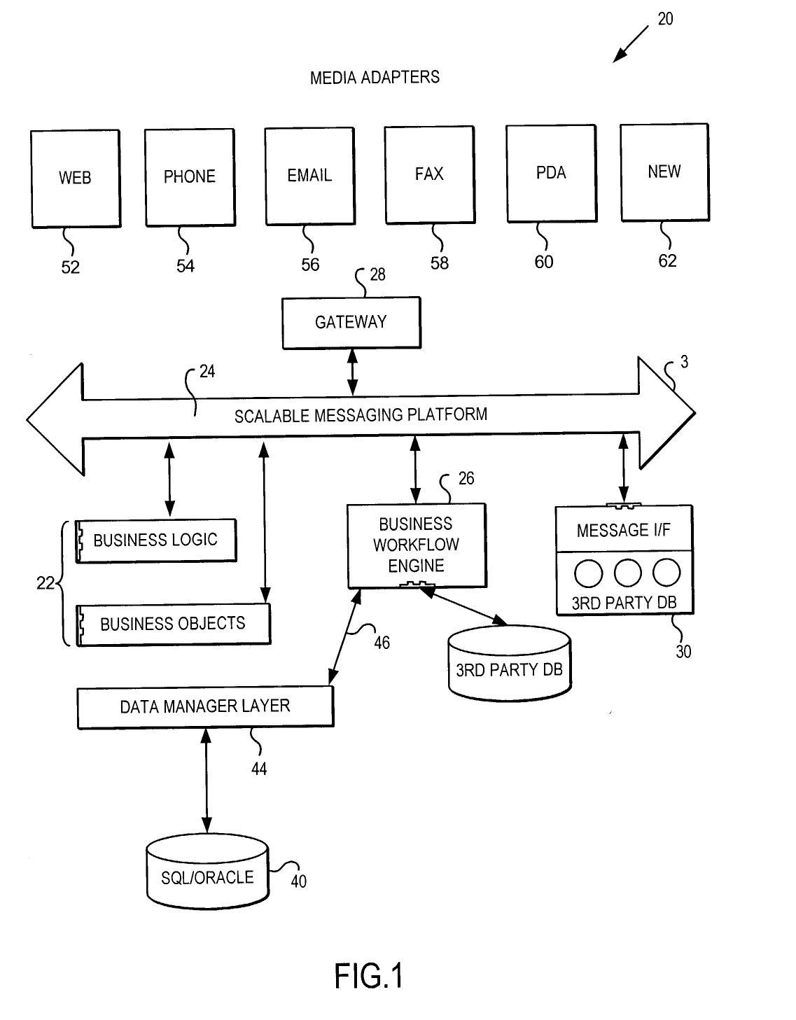

FIG. 1 is a simplified architecture diagram showing the principal components and interfaces of one example of a scalable platform according to the present invention. In particular, FIG. 1 illustrates the conceptual layering and the communications employed. From a high level perspective, the major subsystems are Business Logic and Business Objects 22; Messaging Platform 24; Business Workflow Framework 26; Communications Gateway 28; and Application Integration Framework 30. These elements together form an extensible platform that is easily customized for many different industries and applications; it can be used in almost any commercial business enterprise, as further explained later.

Business Logic and Business Objects

The Business Logic and Business Objects 22 provide the means for managing and interacting with stored data. Preferably, a standard, commercially available database system, for example an SQL system from Oracle, 40 in FIG. 1, is implemented. The database 40 stores tables of data, as is conventional in a relational database, including data objects. These are accessed using standard queries by the Data Manager 44. The Data Manager decouples the rest of the system from the underlying database technology so that any appropriate database system can be used, and upgraded if necessary without changing the platform.

The Data Manager 44 translates business operations into the query language of the underlying database, so that business workflow operations (further discussed later) are database independent. The Data Manager also manages database connection pooling, so that a limited number of connections can be used while executing queries from multiple processes as needed. This helps to contain database licensing costs. In general, the Data Manager provides database access to the Business Workflow Engine 26 as indicated by interface arrow 46.

The Business Objects and Logic subsystem offers a consistent view of platform data and allows clients to perform high-level operations on these data. By “consistent view” we mean essentially that all of the various communication channels, workflow processes and applications utilize (and update) the same data, so it is necessarily consistent. For example, a given product description will be the same, whether accessed by a customer via fax or on the web.

High-level operations are enabled so that business logic and business objects “fit” the industry or application in which the platform is deployed. In a medical clinic application, for example, “customers” become “patients” and “products” may be medical procedures. Toward that end, “business objects” are software objects, including defined views, that are appropriate to the field of the application. The range of applications is virtually unlimited—examples include medical, education, real estate, automotive manufacturing, environmental cleanup, legal just to name a few. Thus a legal business object may be a will, or a litigation, or a court decision or a patent. An environmental business object may be a Superfund site, or a chemical, or an Environmental Impact Statement, etc. Business Logic is again somewhat “vertical,” i.e., directed to specific industries or applications. Business logic imposes qualifications, constraints or operations on business objects, which can be thought of as rules, appropriate to the application.

The Business Objects and Logic subsystem also addresses system-wide common functions such as security, licensing, database access, and resource optimization. This functionality is exposed via the platform business API. In a presently preferred embodiment it comprises a Java® API and comes with XML “helpers” that provide efficient conversion between XML and Java objects. It also supports extensibility mechanisms for modifying or adding business rules, adding new business objects, and configuring for organization-specific databases and servers.

Security

In a presently preferred embodiment, the business platform implements a secure data access system that is useful with systems that have only one database, but can also be used with systems that have multiple databases. The security system uses rules to determine which resources of the database the user may access, which the user may view, and which resources the user may manipulate. In order to make this determination, the user is assigned at least one “role”, which determines, with few exceptions, the user's rights and privileges with regard to resource access and restrictions on resource viewing and manipulation once accessed. Thus, roles and rights and privileges determine to a large extent the user's capability to meet the security system's criteria for accessing resources in the database.

In order to administer database security, several strategies can be employed. These strategies include a hierarchical approach to organization of resources in a database; the use of “roles” that are applied to users (“accessors”) of the system, the use of automatic configurations to control access through roles; and the use of a query sub-system that permits the accessor to access only those resources that the user's role allows the user to “see” and to manipulate through rights and privileges that are granted to the accessor by the system. Each of these concepts are explained in more detail in our copending, concurrently filed application entitled, “Dynamic Rules-Based Secure Data Access System for Relationship Platforms,” U.S. application Ser. No. ______.

In a business context, it may be desirable for certain people to have access to only information pertaining to certain business functions. For example, it may be desirable to restrict access of the sales force to sales information, and not to provide accounting information to sales representatives. On the other hand, it may be desirable to allow marketing personnel (or only certain ones of such personnel) access to sales, accounting, and customer relations information. Each business organization will have specific requirements, and the invention has the flexibility to accommodate these varying requirements. In accordance with the invention, each user that is allowed to access the system is assigned a “role” which is a designation of that person as an individual based on that individual's business function, and the user may be assigned other roles, based on groups to which that user belongs in the organization. Thus, each user may have multiple roles. For example, John Smith may be assigned a role of salesman, and may also be part of a “group role”, the sales reps group. Thus he has access based on two roles. He might further be assigned a role as a customer support person, and so have access to resources available to customer support personnel.

As an initial matter, business functions within the organization may be identified in setting up the secure access system. For example, sales, marketing and customer support. Once business functions have been identified, resources relating to these business functions resources may be organized, so that when a person who has been granted access rights (an “accessor”) to a particular business function, as explained below, accesses the resources of that business function via a terminal, the resources of that business functions are available to it on one or more screens. However, in most business organizations, it is not desirable for everyone to have access to all of the information relating to a particular business function. Hence, in accordance with the invention, each business function is further subdivided into “business objects”. These business objects are groupings of resources within the business functions, and relate to a collation of related business information. For example, while a business function is “Sales”, a business object may be “customers” in a certain geographic region, another business object may be a grouping of certain “products”; and another business object may be “sales opportunity”.

In addition, the resources may be further divided into “attributes”, and these attributes may be accessed by those that have been authorized by assigned role or otherwise. Thus, a business object may have a multiplicity of attributes, and rights to access these may be selectively allowed or denied to accessors based on their roles. Attributes can be base data types like integer or character string; or can be other business objects. It is often desirable to further restrict the access of users of a system, so that even at the business object level, users may not access all the resources within each business object. For this reason, the invention provides a further level of data access control. Each business object is further organized into “instances”. Thus, for example, while the Sales function (as explained) may be divided into several business objects, the customer business object may in turn be further divided so that each customer is an instance.

The above hierarchical system of setting up at least four layers (functions, business objects, attributes and instances) within each business function provides a basis for controlling access to resources of the business function (i) at the business function level, (ii) the business object level, and (iii) the instance level. Thus, for example, a sales manager may have access to the entire sales function, and would be able to see on his screen all resources relating to sales. A regional sales manager may have access to only sales within a geographic area that she controls, and her screen would only display the resources of that business object. In accordance with the invention, these screens may be configured so that information that the manager is not authorized to access, will not display as “blanks” or in any other way indicate that not all information is being displayed. In other words, as far as the regional manager with access to only her authorized business objects is concerned, she may be lead to believe from her screen that she is accessing all resources.

In the preferred embodiment, platform information is formally described in a published data model, and implemented in a commercial relational database. Access to the data is accomplished through well-defined transactions and queries implemented in a multi-tier architecture to ensure scalability and performance. Tables and their interdependencies are mapped onto Business Objects (BO) as noted above. A predefined though API extensible Business Logic is used to provide interactions across BOs. Further queries can also be written to support arbitrarily complex logic for a business.

The Data Manager (DM) component 44 can be used to invoke any object or query. DM basically contains classes that act as an interface to the applications and the database. The classes get the requests from other components or applications and service them efficiently, so that the latter need not have to deal with the database specific details. To provide efficiency and maximal reuse of resources, the DM pools database connections across users. Configuration parameters are provided for setting the maximum number of connections to be opened. Methods are provided to validate the connections and clean up any expired connections from the pool.

Applications require well-defined means of obtaining business data either solitarily (retail mode) or in bulk. The present platform provides the following techniques to make this possible. These are collectively called object-querying methods as each mechanism returns complete business data objects (on success) or none at all (if the query failed). (Integration of third-party applications, with respect to messaging and communications, is discussed later.)

Object naming: This is a retail-mode mechanism where an application can get a business data object from its persistent storage if it can provide a name for that object. The name is also known as the URL. Typically an application creates a business object, asks the API layer to store that object, and then gets the URL of that object. If it remembers the name, SRP can help the application reconstruct the object back from storage. Internally, the URL of an Object will carry sufficient information to identify the object, such as the type of Object, its relationship with the Database (persistent storage).

Simple Query Building: This is a bulk-mode mechanism that allows an application to simultaneously obtain more than one object. This is a primitive OQL-like query (except that there is no language). A simple object query in this manner can specify join relationships between multiple objects, Boolean logical conditions and even supports nesting queries within other queries. The result of executing the query is formulated as a collection of ordered collections. In addition to the objects themselves, it contains control (meta) information about the objects themselves.

Steps involved in using this mechanism are:

1. Create or acquire the objects implementing a simple query.

2. Supply the objects that are to be queried along with relationship among them

3. (Optional) If using a nested query, supply the Object attribute info.

4. Supply the Criteria if any, for attribute of Object participating in the query

5. Execute Query to get the Collection of objects

Pre-defined Query: This is a bulk-mode mechanism used when it is not possible to use the Simple Query builder. The Query is pre-built to retrieve a set of business Objects that have complex relationship amongst them or their selection criteria are quite complex. The result of executing this query is formulated as a collection of ordered collections. In addition to the objects themselves, it contains control (meta) information about the objects themselves.

Generic Query Object: This is a bulk-mode mechanism used if none of the previous techniques are suitable. This mechanism requires explicit knowledge of SQL and of the database. The result of executing this query is formulated as a collection of ordered collections. Unlike other query operations it returns only the individual attribute values (as in SQL). They bear no direct relationship with objects.

Platform Administration

The business platform described, once deployed, interacts with numerous users, clients, customers, etc., with minimal maintenance. For example, as explained later, it automatically “scales” to accommodate increases in user traffic or “events”. Nonetheless, some administration is necessary, especially prior to deployment and for subsequent “fine-tuning” or the introduction of new functionality. An administrative “console” (now shown) preferably includes on-screen interfaces or “screens” to (1) define business logic; (2) define business objects; and (3) define business workflows (see Workflow Editor below). These three activities, all somewhat interrelated, together define the application logic that transforms the generic platform into a specialized application specific platform.

Business Workflow Engine Overview

The Business Workflow Framework offers a flexible, extensible, visual programming platform for automating routine customer interaction tasks and business processes within an organization. Easy-to-use editors enable the user to define workflows that get triggered in response to events in the systems. These events could be incoming interactions such as phone call, fax, emails, and web-form submissions or business events such as overdue tasks or imminent expiry of warranty periods or other organization-specific events. Wizards can be implemented to simplify tasks such as getting a web form to trigger a workflow. Workflows themselves are defined in terms of steps such as creating or modifying a business object, creating and sending an email or fax, making a decision based on a query, scheduling a timed event, and so on. It is also possible to create custom steps as well. A versatile business workflow engine is responsible for scheduling and executing the workflows. Its flexible design makes it possible to execute custom workflow steps in an isolated environment for better fail-safety. The Business Workflow Engine is described in greater detail in our copending, concurrently filed U.S. patent application Ser. No. ______.

Various communication channel adapters exchange messages with the workflow engine and other processing modules via a scalable messaging platform 24. Referring to FIG. 1, it illustrates a Web adapter 52, a phone adapter 54, an e-mail adapter 56, a fax adapter 58 and a PDA adapter 60. New adapter 62 illustrates deploying an available adapter for any new communication medium.

Messaging Platform

The Messaging Platform subsystem 24 is not literally a message highway or bus as illustrated conceptually. Rather, it comprises a collection of processes or agents forming part of the integrated data and event management scheme. In a presently preferred embodiment, the message platform is compliant with the Java Message Service (JMS) standard. Each user of the message platform (a client) interfaces with an appropriate adapter that, in turn, interfaces to a connector that actually connects to the platform, in that the connector can send and receive messages to and from platform processes called agents.

The message platform implements two primary forms of communication: Request-reply transactions—for instance, a user application needs to request configuration data from a server DB application; and Publish-Subscribe Messages—in which messages of selected types can be published using the message platform client ID to carry messages to user applications subscribing to those types of messages. In addition, monitoring applications (tracing, statistics, utilization monitors, etc.) can also subscribe to this information without any impact on network or server performance—the message is still only sent out on the message bus once.

All communication among internal components takes place on the Message Bus. Applications can utilize multiple ports to communicate between various modules in a point-to-point, as well as in a publish-subscribe (Write One Read All) fashion. The message bus will take care of:

Connection management and scalability

Message assembly and hiding the internal structure of a message

Marshalling/unmarshalling data within messages

Reliability

Message routing and subscription management

Subscribing and un-subscribing to messages is very fast, such that it is possible for applications to make and break subscriptions on a per-contact basis (if necessary) without causing undo overhead on critical server or network resources. Additional optimizations can be implemented for communications that occur on the same node through the use of shared memory.

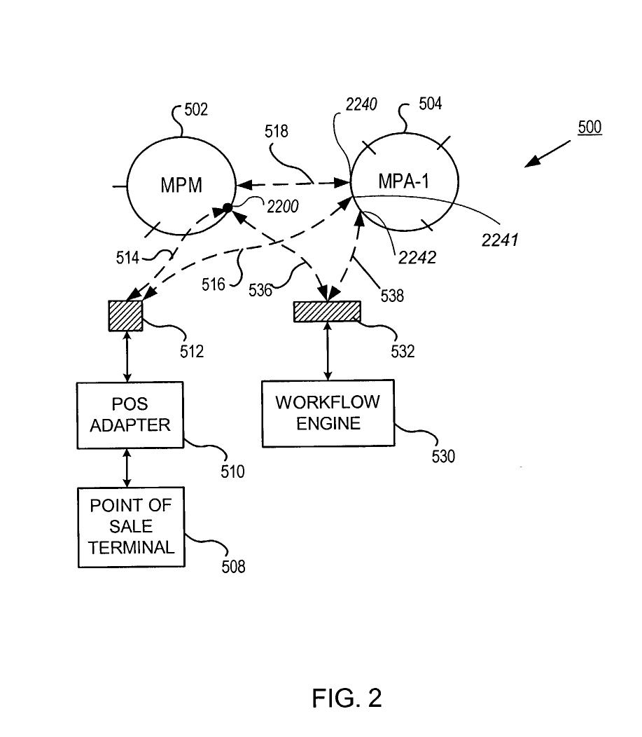

FIG. 2 is a first conceptual diagram illustrating operation of the messaging platform of FIG. 1. The messaging platform 500 includes at least one messaging platform manager (“MPM”) process 502 and at least one message platform agent (“MPA”) component 504. The message platform manager 502 starts up at initialization and creates the first MPA, in this case, MPA-1 504. The message platform manager oversees operation of the messaging platform, and implements additional connection ports as follows: First, the MPM 502 implements a well-known port number, here 2200, which will be used by any component seeking a connection to the message platform. When the MPM creates a message platform agent (MPA), it assigns a range of port numbers to that agent, and maintains a record of port assignments as further explained later.

In this example, we assume that the MPM implements port numbers 2200 to 2239 (although it only needs a few port numbers, as will become apparent) and it assigned port numbers 2240-2269 to MPA-1 when it was created. Next, we assume that an electronic point-of-sale terminal 508 is to be integrated with the present business computing platform. The point-of-sale (POS) terminal 508 is connected to a point-of-sale adapter 510. The point-of-sale adapter is arranged for communication with the POS terminal and is capable of buffering and reformatting data as appropriate to send and receive messages via the message platform 500. The POS adapter 510 is connected to a connector process 512, which is directly responsible for monitoring message traffic on the message platform and sending messages from the POS adapter.

Initially, the connector 512 sends a message 514 to the well-known port number 2200 requesting registration with the platform. The MPM 502 responds with a message assigning a port number for the connector 512 to use, in this case port number 2241. Logic in the connector 512 will then send a message 516 directed to port number 2241 which in FIG. 2 is implemented by MPA-1. (In the drawing, port numbers are shown in italics to distinguish from component reference numbers; also, port numbers are 2200 and higher in this illustration.) Communicating on the assigned port number 2241, the POS adapter then registers with the message platform as further explained below.

The message platform agent MPA-1 maintains a connection table internally that reflects each of the components registered with that agent. Here, that table will include an indication that the POS adapter is connected at port number 2241. As other components register, or unregister (become unavailable), MPA-1 updates its internal connection table, and it periodically transmits messages 518 to the message platform manager (MPM) process to update that information. In other words, a message platform update message includes in its payload the source MPA's connection table.

Next, a workflow engine 530 is initialized and seeks registration onto the message platform. The workflow engine 530 is coupled to a connector 532. As before, connector 532 sends a message to well-known port number 2200 requesting a connection to the message platform. MPM 502 examines its internal connection table and determines that the next available port number is 2242. It assigns that port number to the connector 532 via a message 536. In response, connector 532 sends a registration message 538 to MPA-1. As before, MPA-1 updates its connection table and furthers that information via message 518 to the platform manager 502. (Connection table management is further described below.) During subsequent operation, whenever the POS terminal 508 or the workflow engine 530 transmit a message onto the bus, the MPA-1 examines its connection tables to locate the indicated destination, and forwards the message to that port.

The message platform implements both request-reply transactions, as well as publish-subscribe transactions; the latter is implemented as follows. When a component/connector registers with the assigned MPA, it sends a message that includes an indication of those message types to which the component wishes to subscribe. In other words, it lists those classes of messages which should be forwarded to that component. Each component can subscribe to receive zero or more types of messages. (It may be a producer only.) By limiting its subscription to the types of messages required for its operations, message traffic is reduced and therefore efficiency and scalability are improved. Similarly, when a component/connector registers with the corresponding MPA, it can also include an indication of the message types that it will publish. Both publish and subscribe information is stored in the MPA local connection table, and is included in the connection data forwarded to neighboring message platform processes for routing purposes.

The message platform can be implemented using either a star or a serial chain configuration. The serial chain is presently preferred and is illustrated in the drawings. In that scenario, each MPA is connected to two adjacent neighbors, except for the MPM and the last MPA which form the endpoints of the chain.

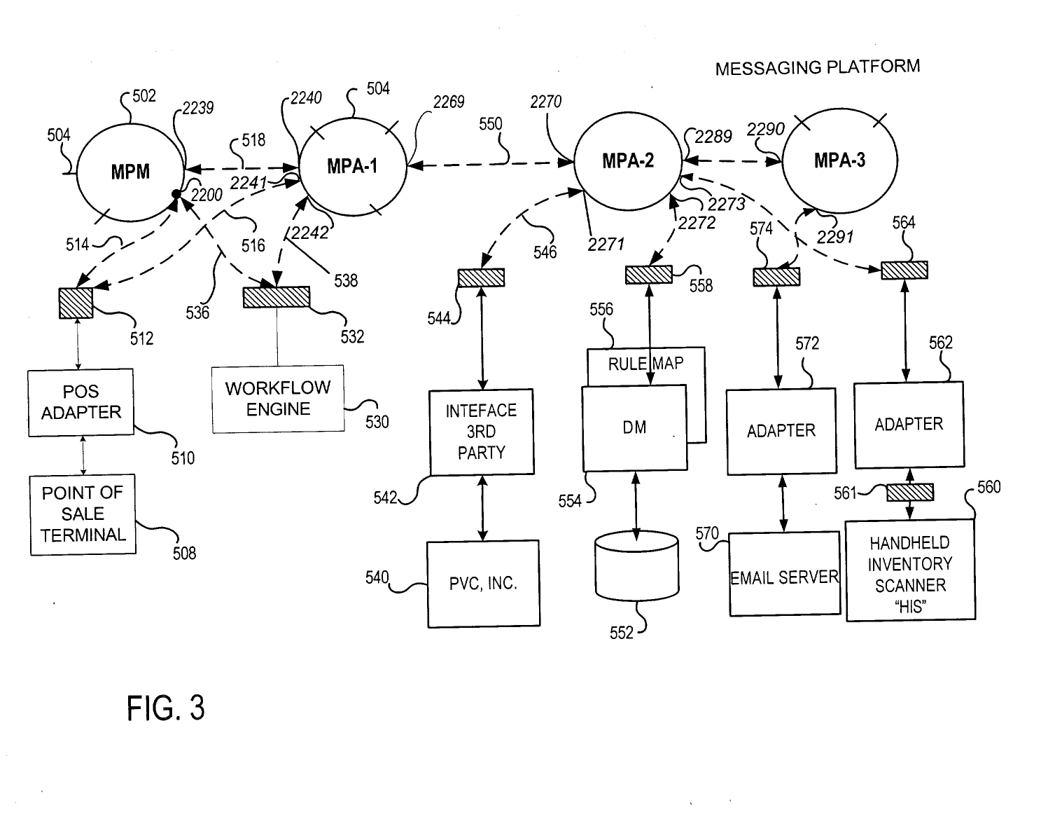

FIG. 3 is a second conceptual diagram illustrating operation of the message platform of FIG. 1. The left portion of FIG. 3 is substantially the same as FIG. 2. FIG. 3 illustrates further evolution of the message platform. As shown in FIG. 3, the MPM has spawned a second message platform agent MPA-2 to implement additional communication ports. We assume for illustration that the MPM assigns port numbers 2270-2289 to MPA-2. This information is retained as part of the connection table in the MPM.

Next, we assume that this business platform requires integration with a third-party vendor, in this case a company called PVC, Inc., a vendor of PVC pipes. The vendor's system 540 is coupled to a third-party interface 542 which includes logic for transferring messages, protocol conversion, and the like. Preferably, messages employ XML as a convenient mechanism for data exchange between disparate systems. The third-party interface 540 in turn is connected to a connector process 544 for interaction with the messaging platform. As before, the connector 544 initially contacts the MPM by sending a message to the well-known port number 2200. This is not illustrated but we assume that the MPM assigned port number 2271 to the third-party interface. Accordingly, the connector sends a message 546 to port 2271 on MPA-2 to register the PVC, Inc. connection. That registration can include an indication that PVC, Inc. subscribes to messages of the type vendor VEND_ and that it will publish messages of that type.

The illustrative system also implements an inventory database, preferably employing an industry standard database management system, such as an SQL system 552. The database system is connected to a data management (“DM”) component 554 of the type described above with reference to FIG. 1. The data manager maintains a rule map 556 indicating what business objects are stored in which database tables. The data manager communicates with a connector 558 process to access the messaging platform. We assume the initialization process described above, resulting in assignment of port number 2272 to the data manager. The data manager registers with MPA-2 to publish and subscribe to messages of the type inventory INV_.

A handheld inventory scanner device (“HIS”) 560 is used to take a physical inventory by an individual who moves about the warehouse scanning bar code numbers and entering quantity information. The HIS is then temporarily connected to the platform via a cable/connector 561 and adapter process 562. The HIS adapter includes logic for downloading inventory data from the HIS and formatting that information for transmission onto the messaging platform 500. The HIS adapter is connected to the platform via connector 564 to port number 2273, as shown. It is initialized and registers to publish and receive messages of the type inventory INV_.

The following table 1, “Messaging Platform Connection Table,” summarizes the messaging platform described thus far and provides an indication of the contents of each of the message platform processes.

TABLE 1
Messaging Platform Connection Table

| | CONNECTOR | PORT | PUBLISH | SUBSCRIBE |
|---|---|---|---|---|
| MPM | Well-known | 2200 | | MP_{—} |
| | MPA-1 | 2239 | MP_{—} | MP_{—} |
| MPA-1 | MPM | 2240 | MP_{—} | MP_{—} |
| | WF | 2242 | INV_{—L ,} | INV_, |
| | | | MAIL_, | MAIL_, |
| | | | VEND_{—} | VEND_{—} |
| | POS | 2241 | VEND_{—} | VEND |
| | MPA-2 | 2269 | MP_{—} | MP_{—} |
| MPA-2 | MPA-1 | 2270 | MP_{—} | MP_{—} |
| | TPI-1 | 2271 | VEND_{—} | VEND_{—} |
| | DM | 2272 | INV_{—} | INV_{—} |
| | HIS | 2273 | INV_{—} | INV_{—} |
| | MPA-3 | 2289 | MP_{—} | MP_{—} |
| MPA-3 | MPA-2 | 2290 | MP_{—} | MP_{—} |
| | E-MAIL | 2291 | MAIL_{—} | MAIL_ |

For each connection to a message platform process, there is an entry in the table comprising an identifier of the connected process, assigned port number, publication message types and subscription message types. The messaging platform manager MPM implements the well-known port number 2200 which is not configured to publish any messages, but subscribes to receive messages of the message platform type MP_. The MPM has allocated port numbers 2200-2239 to itself, although only the first and last ports are active. The last port number 2239 provides a connection to MPA-1, as indicated, and MPA-1 is registered to both publish and subscribe to message platform-type messages. The remainder of the table is self-explanatory and reflects the drawing FIG. 3.

The business platform illustrated in this example implements at least four classes of messages, namely message platform (MP_), inventory (INV_), e-mail (MAIL_), and vendor (VEND_). As the names imply, the MP class messages relate to maintenance and operation of the message platform itself. The inventory class of messages pertain to querying and updating the inventory database. The e-mail messages pertain to sending and receiving e-mail traffic. The vendor class of messages pertain to transactions with a connected third-party vendor, such as PVC, Inc., as illustrated in FIG. 3. Almost any combination of any number of components can be interconnected using a messaging platform of the type described. From a practical standpoint, a basic framework of preconfigured components is provided in a commercial embodiment of this platform, which can then be customized by the customer to conform to the its preferred business logic, practices and procedures.

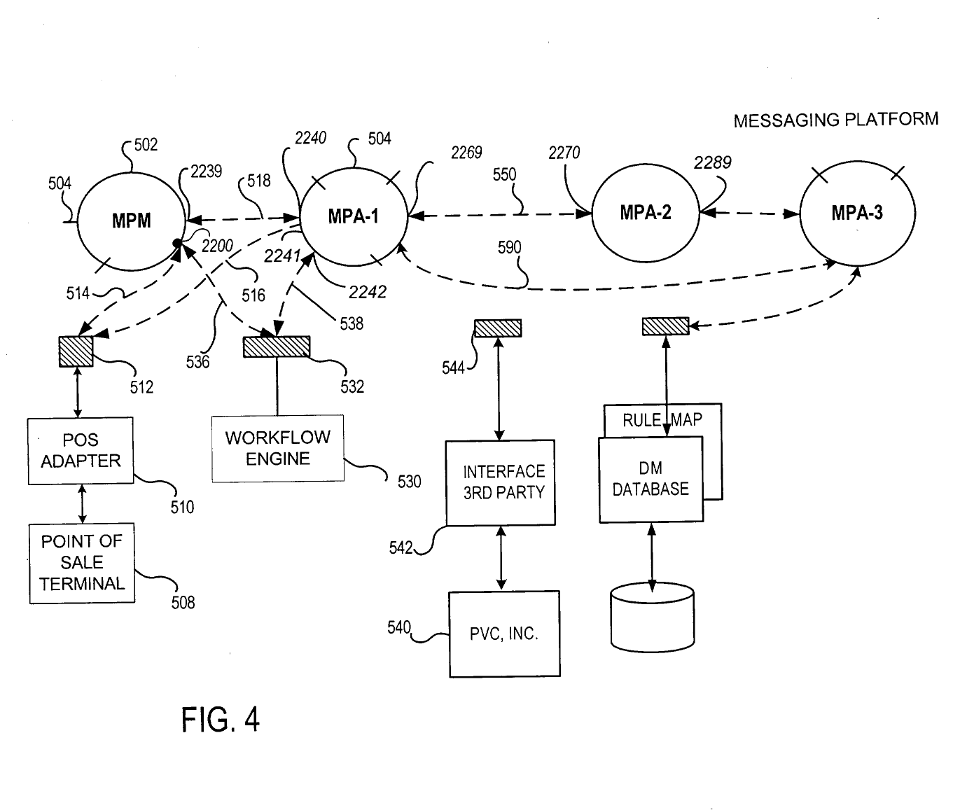

FIG. 4 illustrates a mesh-type connection 590 established on the messaging platform as a direct connection between agents MPA-1 and MPA-3. This can be implemented as an alternative to the serial chain mechanism described above. A mesh connection strategy imposes greater setup overhead (and latency) but can improve performance in some situations.

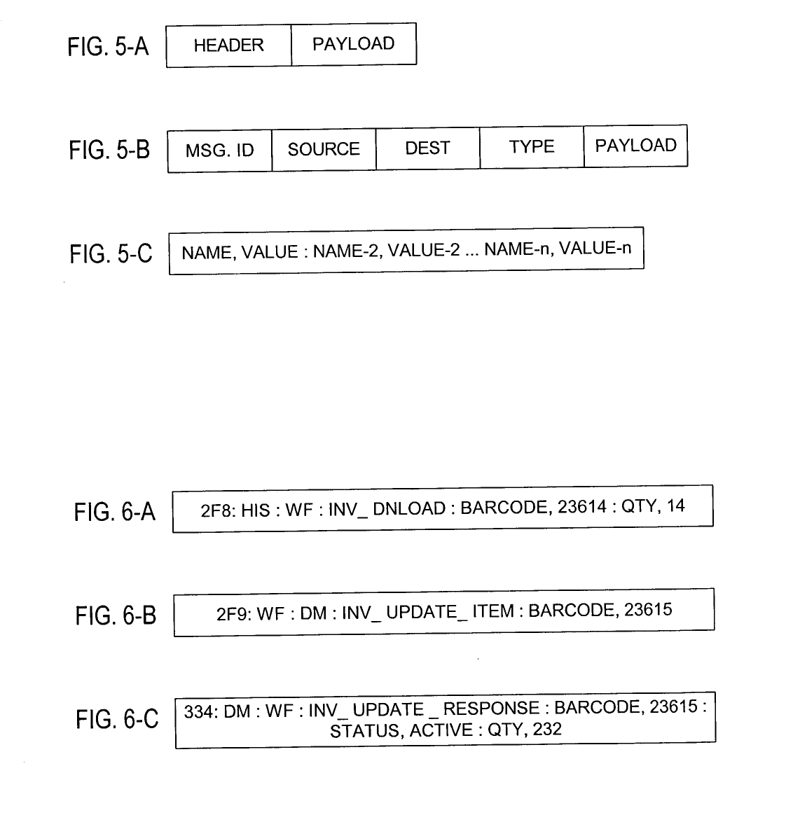

FIG. 5A shows an illustrative message format consisting of a header field and payload. The header field can include, for example, message ID (a serial number to identify the message and its sequence), source, destination and message type fields, as illustrated in FIG. 5B. FIG. 5C illustrates a payload format, comprising a series of field name and value pairs.

Examples of some specific messages are provided as follows. FIG. 6A illustrates a message sent from a hand-held inventory scanner (560 in FIG. 3) to a workflow engine. The message type INV_DNLOAD (inventory download) is an instance of the inventory class of messages. The payload in this example consists of two field name-value pairs, specifying a bar code number and a quantity. This is an example of a message that might be sent across the platform to update inventory records based on a physical inventory that was taken using the hand-held scanner. Referring to FIG. 3, the data originating with the hand-held scanner, and formatted by the HIS adapter 562, travels via the connector 564 to the assigned port 2273 on the platform agent MPA-2. Agent process MPA-2 consults its connection table and determines that the destination, workflow engine, is connected to a port (2242) on MPA-1. MPA-2 forwards the message accordingly. More specifically, MPA-2 determines that the workflow engine subscribed to receive messages of the inventory type (among others) as shown in the platform connection table above.

Referring now to FIG. 6B, this illustrates a message generated by the workflow to update the inventory database. It shows the workflow as the source, data manager as the destination, and the message INV_UPDATE_ITEM that is an instance of the message class INV_, and finally the payload comprises a single name-value pair, namely barcode number 23615. The workflow engine message traverses connector 532 to port 2242 on MPA-1 as shown in FIG. 3 and the connection table. MPA-1 consults its connection table and determines and identifies all of the components that have subscribed to receive messages of the inventory type. These include the data manager at port 2272 as well as the HIS at port 2273. (The HIS adapter 562 can buffer data when the HIS device is not attached.) The MPA forwards the message to the components that have subscribed.

The data manager will respond to the inventory update request by accessing the inventory database 552. The data manager maintains a rule map 556 for translating this type of business object update into a standard form query to the appropriate database table. FIG. 6C is an example of a message that might be sent from the data manager to the workflow engine providing a response to the inventory update request just described. The response in this case comprises three name-value pairs, namely the barcode number, the status of that barcode number, and the updated quantity of the corresponding item in inventory. The data manager includes secure infrastructure for accessing the database as described above.

In operation, the message platform connection data is dynamically updated and propagated as follows. The user can observe that each MPA process is connected to its left and right neighbors. These connections are assigned to corresponding communication ports, just as ports are assigned to connector processes. Thus, as indicated in the table (and FIG. 3), MPA-1 has its port number 2269 assigned for connection to MPA-2. Conversely, MPA-2 has its port number 2270 assigned for connection to MPA-1, and so on, so that these agents for a serial chain. The message platform agents communicate connection data to one another at regular intervals, or when changes occur, or “piggybacked” onto client messages. (Here we refer to a client of the messaging platform, i.e., a process coupled to the platform, for example through an adapter or third party interface.)

A message platform update message would be generally of the form MPA-X (source): MPA-Y (destination): Payload. Here, the payload is a connection list which may take the form, for example, of four field name-value pairs, where the fields are a connector I.D, port number, publish message types and subscription message types. (This information is acquired during the registration process described below.) The connection list data is provided for each active port of the subject agent. (The logic permits the publish and subscription fields to include multiple arguments.) Importantly, for each agent, two of its ports will be assigned to neighboring agents (except for the endpoints of the chain, as illustrated in Table 1 above). The payload entry corresponding to a neighboring agent will include in it the payload/connection data that the agent sending the present message received from that neighboring agent.

If one imagines these messages traveling from right to left in FIG. 3, from the last agent back to the managing process, one can see that the managing process in fact has a complete image of all active connections at any given time. This allows the MPM to spawn new message platform agents when required, to potentially reassign port numbers that have been closed, and to replace any MPA that no longer responds (died). Logic in the MPM can simply spawn a new agent, assign to it the port numbers previously assigned to the agent that died. This new information will automatically propagate through this system as described. In the chain configuration, each agent has knowledge of the connections to either side of it (immediately or through other agents) so that it can transmit messages to its ports accordingly.

Queuing Messages

The bus implements queuing within the client connector, both for read and write of messages. It provides reliability in delivering messages by implementing an implicit acknowledgement feature between the publisher and subscriber. Further there is a provision to automatically regulate the inflow of messages in the system (from media inboxes) so that a certain level of performance is maintained. Additional optimizations have been implemented in the communication component for server components that run together as a process, through the use of shared memory.

If a component on the messaging platform starts generating messages at a rate much greater than they can be consumed/transmitted by the platform, it could result in the component having to “slow down”. For example, in FIG. 3, both the Workflow Engine 530 and the POS terminal 508 are connected to the message platform MPA-1 504. On a good business hour, the POS terminal could be generating a lot of messages for MPA-1 to handle. If 530 starts getting active because of email and web requests needing to be routed in PVC Inc., MPA-1 504 may not be in a position to read messages from adapter 512 on port 2241. Consequently, the adapter 510 will not be able to post any new messages to 2241, and will stop accepting new messages from 508. In a cascading effect, the POS terminal 508 will not be able to send any messages to 510 and will either stop working or result in a “read error”.

In accordance with another aspect of the present invention, this traffic situation is taken into account by implementing a message queue in the connector and the adapter. The queue can be configured externally to a selected length (number of pending messages) appropriate for such traffic peaks in PVC Inc. The queue allows messages to be released to the next component at a rate that is acceptable to both components. It is like a reservoir of water before a high-rise dam.

In a further example of the system according to the invention, the POS terminal 508 may require all financial sales messages to reach the DM 554. In a conventional system this would require 508 to wait for an acknowledgement of every message it had sent to the DM 554. This would not only affect the performance of 508 and 554, it would also increase the traffic on the messaging platform (double, in this case) causing a negative impact on the performance of the whole system. To avoid this, our invention has introduced the concept of delivering messages reliably to a required destination. This is implemented by a retry mechanism in the queues in the connectors and adapters. This mechanism not only tries to send messages from the queue until they are successfully on the platform, but also implements an implicit acknowledgement scheme with the destination adapter/connector (in this case 558). This scheme allows multiple acknowledgements to be piggybacked on a single message thus reducing the platform load. If the originator 512 determines that a particular message has not be acknowledged (serial number of the message ID is missing in the piggybacked message acknowledgement), it resends it to 558.

Further, if the platform discovers that both adapters 512 and 558 are running on the same physical hardware machine, they will not exchange messages between MPA-1 and MPA-2. Rather, they will communicate using in-memory global data stores that both 512 and 558 can access simultaneously. This further reduces the load on the platform and improves the performance significantly.

Events Model for Third-party Integration

The business platform of the present invention preferably implements application integration, including a business logic API, to enable an external application or system (or many of them) to readily communicate with the platform. Interactions can be implemented in any one or preferably a combination of several ways, as follows.

First, external applications can synchronously interact with the platform business logic API by using any of the industry standard IPC middleware such as DCOM, CORBA, and RMI. Second, external applications can communicate asynchronously using a message oriented middleware (“MOM”). Here, a message dispatcher component routes the messages from the external applications to appropriate internal (platform) components and vice versa. And third, an external application or component can become a more directly integrated “member” of the platform by actually plugging into the messaging platform (through an adapter and connector) as described above. All messages can be based on the XML format. The platform provides the richness of business capabilities, to any interacting XML-based application.

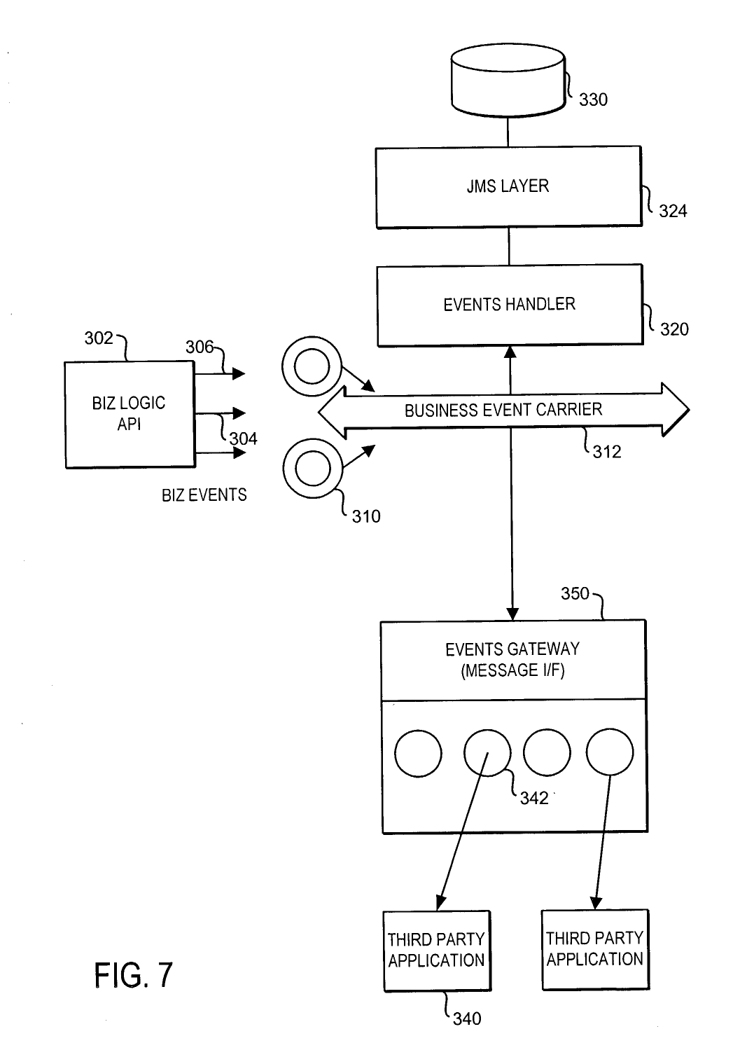

FIG. 7 is a simplified diagram illustrating an events model for third-party integration. Here, a business logic API 302 includes the ability to generate one or more business events 304,306. Generally, an event in the context of business logic is an indication of completion of a business process. Business events generally contain a payload which describes the data generated or affected by the business process. Third-party integration uses this payload. Preferably, the payload of the event can employ XML and comply with industry standards.

Referring again to FIG. 7, a business event is detected by an Event Service client 310. Such a client can be part of the connector (512, 532 and the like in FIG. 3) or the adapter (510, 572 and the like in FIG. 1) if one is connected directly to the messaging platform. The Event Service client 310 publishes the event via a business event carrier mechanism 312 (which could be, but is not limited to, the message platform (24 in FIG. 1) as described earlier) to an events handler 320. Alternatively (or additionally), the Event Service client 310 could publish a message responsive to the event to the messaging platform (24 in FIG. 1), although that method is typically handled by an adapter as described previously.

The message platform (24 in FIG. 1) can work in conjunction with a MOM implementation, and is responsible for maintaining persistent business events. The Events Handler 320 in this figure makes events persistent as needed. It interfaces to a JMS or other standard messaging compliant layer for storing the event in a database 330. Thus an Event Service client can access the database without going through a business workflow and data manager.

Third-party applications 340 can include components that subscribe to receive similar business events asynchronously. For example, a group of applications 340 is conceptually illustrated as having a component 342 that subscribes with an Events Gateway 350 to receive selected finance types of business events as they occur. Conversely, third party applications can be the source, i.e., they can publish selected events to the event service. To summarize, a business logic API fires a business event which in turn is received by an event service client. The ES client publishes the event. An Events Handler can capture the same, and initiate persistent storage if needed. An Events Gateway interfaces to third-party components to deliver events to which third-party applications have subscribed in near real time. All business events will be subscribed by this gateway and forwarded to interested third party applications, thus obviating the need for multiple copies of the same message moving in the messaging platform.

To further illustrate the events interface, we take as an example a vendor-customer relationship, in which the vendor maintains a business computing platform of the type described herein, and the customer maintains its own automated inventory system. The customer's inventory system is arranged to place an order with the vendor when a particular product is running low. This order can be entered through any of the channels (media adapters) described earlier, in which case it will trigger execution of a place order business workflow on the vendor's platform. Alternatively, the vendor's system, using a third party interface to the customer system as described further below, can “listen” for a business event to enter the order. Further, an order processing business logic component fires off an event to acknowledge receipt of the order. That event, in turn, may initiate an email (to the salesman, the customer or both). This can be done by the event handler or as part of a business workflow triggered by the order. The events handler also forwards the event as appropriate, including passing it, for example, to the MOM for persistent storage.

Preferably, all messaging utilizes HTTP or “web services” for convenient communication with desktop applications, via web browser, etc. By using XML for messages (events) internally, the platform can easily and automatically transform a message into a format or namespace specified by the third-party application. This approach closely integrates the platform and the third-party system in terms of functionality, yet does so without retooling or even touching the core “source code” of either system. Further, changes in the third-party system are quite easily accommodated by the vendor platform by changing or replacing the subscribing component.

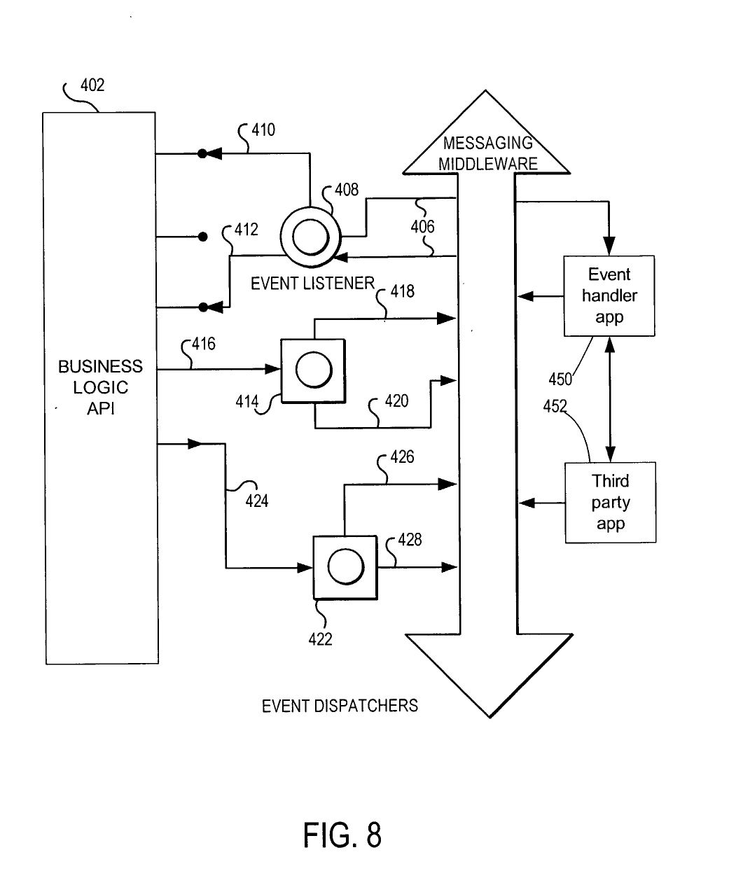

FIG. 8 also illustrates the use of events in the context of a third party interface. Here, a business logic API 402 can send and receive events, through the agency of event listeners 408 and event dispatchers 414, 422. The listeners, for example 408, detect selected events 406 from an MOM layer, which could be the messaging platform as defined in this invention.

An event dispatcher 414, 422 is an object whose sole purpose is to propagate the event—illustrated as 418, 420, 426, 428—to the Event Service. Event service could be an application like a Message Oriented Middleware (MOM, Eg:- MSMQ, Oracle AQ) or the messaging platform as described in this invention. In the presently preferred implementation shown in FIG. 8, the dispatcher sends the event to the MOM. It has the logic built in to talk to various MOM vendors. These may include use JMS—Java Messaging Service (324 in FIG. 7) or JNI-COM layers (not shown). A generic Event Handler application 450 is deployed to process events for third parties 452, either by receiving responses/events

The event listener is a process whose sole aim in the messaging platform is to listen to all the requests of third parties and process the requests using Business Logic API's. This also posts the responses to the requests back to the MOM. Event Listener could either pull the events/requests from MOM or MOM could push the events onto the listener. The MOM preferably provides Event persistence, support of multiple consumers for the same event, event expiration, retention and purging. Those skilled in the art will appreciate from this description that the events interface and related components can be configured to implement various push-pull scenarios for interaction with third parties synchronously or asynchronously.

It will be obvious to those having skill in the art that many changes may be made to the details of the above-described embodiments of this invention without departing from the underlying principles thereof. The scope of the present invention should, therefore, be determined only by the following claims.

1. A scalable software architecture for business computer platforms comprising:
a messaging platform for communicating messages among components coupled to the messaging platform;
a communication gateway for communication with at least one external channel, the gateway coupled to send and receive messages via the messaging platform;
a data manager layer for maintaining data in a connected database system, the data manager coupled to send and receive messages via the messaging platform; and
a business workflow engine for implementing predetermined business workflows, the business workflow engine coupled to send and receive messages via the messaging platform.

2. A scalable software architecture according to claim 1 and further comprising a message interface coupled to the messaging platform for exchanging messages between the messaging platform and a third-party application.

3. A scalable software architecture according to claim 1 and further comprising at least one media adapter coupled to the communication gateway for interfacing with a corresponding media channel so as to integrate the corresponding media channel with the business computer platform via the messaging platform.

4. A scalable software architecture according to claim 3 wherein said at least one media adapter implements a mechanism to filter input from the corresponding channel on the basis of predetermined keywords, and to send a message onto the messaging platform responsive to said filtering.

5. A scalable software architecture according to claim 4 wherein the keywords are selected and input by a system manager based on the business application.

6. A scalable software architecture according to claim 4 wherein the keywords are configured in business logic maintained by the data manager layer.

7. A scalable software architecture according to claim 1 wherein the messaging platform includes:
a messaging platform manager (“MPM”) process; and
at least a first messaging platform agent (“MPA”) process associated with the MPM process;
the MPM process and the MPA process configured for interacting with each other to realize the messaging platform;
wherein the MPM process implements at least first and second communication ports, the first communication port comprising a predetermined, well-known port number to receive a request for a new connection to the messaging platform;
and the second communication port configured for communicating with the MPA process; and wherein
the MPM process is arranged to invoke methods for assigning a port number in response to a message received on the well-known port number requesting a connection to the messaging bus.

8. A scalable software architecture according to claim 1 wherein the messaging platform provides registration of connected components to implement request-reply transactions.

9. A scalable software architecture according to claim 1 wherein the messaging platform provides registration of connected components to implement publish-subscribe transactions.

10. A scalable software architecture according to claim 1 wherein the messaging platform provides event services.

11. A scalable software messaging platform comprising:
a messaging platform manager (“MPM”) process; and at least a first messaging platform agent (“MPA”) process associated with the MPM process;
both the MPM process and the MPA process executable and capable of interacting with each other to form a messaging platform;
wherein the MPM process implements at least first and second communication ports, the first communication port comprising a predetermined, well-known port number to receive a request for a new connection to the messaging platform;
and the second communication port configured for communicating with MPA process.

12. The software messaging platform of claim 11 wherein the MPM process is arranged to invoke methods for
assigning a port on the messaging platform in response to a message requesting a connection to the bus; and
maintaining a table of current message platform connection data.

13. The software messaging platform of claim 12 wherein said method for assigning a port includes sending a message to the source that requested the connection, said message including a port number serviced by one of the MPA processes associated with the MPM process.

14. The software messaging platform of claim 11 wherein the MPM process is arranged to invoke methods for
creating a second MPA to provide additional ports for connection to the platform; and updating the message bus connection data to include the second B bus-router process.

15. The software messaging platform of claim 11 wherein the MPM process is implemented as a software object, and said method for creating a second MPA comprises spawning the second MPA as a child process of the MPM process.

16. The software messaging platform of claim 11 wherein the MPM process method for updating the message bus connection data includes storing the said data locally.

17. The software messaging platform of claim 11 wherein the MPA process includes methods for opening a connection at a port number assigned by the MPM process.

18. The software messaging platform of claim 17 configured to transmit messages to implement request-reply transactions.

19. The software messaging platform of claim 17 configured to transmit messages to implement publish-subscribe transactions.

20. The software messaging platform of claim 17 wherein the MPA process includes methods for receiving a message via the open connection from a connector process, and for registering the component associated with the said connector process.

21. The software messaging platform of claim 20 wherein the MPA method for registering a connected component includes receiving from the component an indication of a subscription to receive at least a selected one of a predetermined set of message types; and storing said subscription.

22. The software messaging platform of claim 20 wherein the predetermined set of message types is established by configuration of the messaging platform and is maintained by the MPM process.

23. The software messaging platform of claim 20 wherein the predetermined set of message types includes at least one message type dynamically associated with a client currently connected the messaging platform.

24. The software messaging platform of claim 20 wherein the set of message types includes a data management message type.

25. The software messaging platform of claim 20 wherein the set of message types includes a client registration message type for registering a client with the MPA process to which is it connected.

26. The software messaging platform of claim 20 wherein the set of message types includes a messaging platform synchronization message type for sharing connection data among the MPM and MPA processes.

27. The software messaging platform of claim 26 wherein the synchronization message includes a component identifier, port number, indicia of requested publication message types and indicia of requested subscription message types.

28. The software messaging platform of claim 20 wherein the MPA method for registering a connected component includes receiving from the component an indication of a subscription to receive at least one of a predetermined set of message types; and storing said subscription.

29. The software messaging platform of claim 20 wherein the MPA method for registering a connected component includes receiving from the component a request to publish via the messaging platform at least one of a predetermined set of message types; and storing said publication request.

30. The software messaging platform of claim 20 wherein the MPA includes methods for maintaining a port number assignment table.

31. The software messaging platform of claim 30 wherein the port number assignment table includes indicia of the last port number assigned for each live MPA process.

32. The software messaging platform of claim 30 wherein the MPA includes methods for communicating the table of active connections to neighboring MPA so as to form a serial chain to propagate message bus connection data.

33. The software messaging platform of claim 20 and further comprising a second MPM process and at least one MPA process associated with the second MPM process for bifurcating the messaging platform.

34. A scalable software messaging method comprising the steps of:
providing a messaging platform manager process;
establishing a well-known port number implemented by the messaging platform manager process;
receiving a message at the well-known port number from a client requesting a connection to the messaging platform; and
assigning to the client a port number other than the well-known port number for connection to the messaging platform to send and receive subsequent messages.

35. A scalable software messaging method according to claim 34 further comprising creating a first messaging platform agent process; associating the first agent process with the messaging platform manager process; and allocating at least two port numbers other than the well-known port number to the first agent process.

36. A scalable software messaging method according to claim 35 wherein said assigning a port number to the said client comprises assigning one of the port numbers allocated to the first agent process, whereby subsequent messages to and from the client do not require connection to the messaging platform manager process.

37. A scalable software messaging method according to claim 35 and further comprising spawning a second agent process to implement additional port numbers; and associating the second agent process to the first agent process in a serial chain relationship.

38. A scalable software messaging method according to claim 35 and further comprising: maintaining current connection data in each agent process; and communicating the current connection data from each of the agent processes to the messaging platform manager process.
